(19) United States
(12) Patent Application Publication
(10) Pub. No.: US 2026/0171748 A1
(43) Pub. Date: Jun. 18, 2026

(54) LASER MATRIX FOR OPTICAL NEURAL NETWORKS

(71) Applicant: Microsoft Technology Licensing, LLC, Redmond, WA (US)

(72) Inventors: Esa Tapani RÄIKKÖNEN, Espoo (FI); Tuomo Antero VON LERBER, Helsinki (FI); Lasse-Petteri LEPPÄNEN, Kirkkonummi (FI); Henri Tuomas Antero JUSSILA, Espoo (FI); Joona Juhana KOPONEN, Vantaa (FI)

(21) Appl. No.: 18/979,013

(22) Filed: Dec. 12, 2024

(51) Int. Cl. H01S 3/23

(52) U.S. Cl. CPC H01S 3/2391

(57) ABSTRACT

A laser system comprises (i) one or more pump light sources configured to generate pump light, the pump light comprising a first wavelength; (ii) one or more injection lasers configured to generate injection light, the injection light comprising a second wavelength that is longer than the first wavelength; (iii) one or more light modulators configured to selectively modulate the injection light received from the one or more injection lasers to produce input signal light; and (iv) a laser cavity matrix comprising a plurality of laser cavities, wherein each laser cavity of the plurality of laser cavities comprises a laser gain medium and is configured to (a) receive pump light from the pump light source(s) to cause stimulated emission within the laser gain medium to generate an output laser light and (b) receive input signal light from the light modulator(s) to cause injection locking of the output laser light.

### BACKGROUND

Artificial intelligence (AI) solutions have been developed and applied to different problems and tasks in various industries. Many AI solutions are implemented using machine learning models that are trained on large datasets to recognize patterns, make predictions, provide classifications/labels, etc. These models can take on various forms and architectures, such as neural networks, decision trees, support vector machines, and/or others. Common neural network architectures include convolutional neural networks (CNNs), recurrent neural networks (RNNs), long short-term memory (LSTM) networks, and transformer models. Such models are often deployed on cloud platforms, servers, or specialized hardware.

Hardware acceleration refers to the use of specialized hardware components to perform specific computational tasks more efficiently than general-purpose central processing units (CPUs). Specialized hardware components can be designed to handle the parallel processing and high computational demands of machine learning tasks. Hardware acceleration can significantly speed up the training and/or inference of machine learning models, enabling faster and more efficient AI solutions.

The subject matter claimed herein is not limited to embodiments that operate only in environments such as those described above. Rather, this background is only provided to illustrate one example technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIG. 1 illustrates a conceptual representation of components of a laser system for optical neural networks.

FIG. 2 illustrates a conceptual representation of laser resonators of a laser system for optical neural networks.

FIG. 3 illustrates a conceptual representation of components of another laser system for optical neural networks.

FIG. 4 illustrates a facing view of example laser matrix configurations for a laser system.

FIG. 5 illustrates example components of an example system that may include or be used to implement one or more disclosed embodiments.

### DETAILED DESCRIPTION

Disclosed embodiments are generally directed to laser matrices for optical neural networks, where injection-locked lasers are used as neurons and lights is used as an information carrier. A single laser or a collection of lasers may serve as an artificial neuron. Under one characterization, the laser may be regarded as the soma, or the part of the neuron that accumulates signals from its receptive field and performs some nonlinear operation before outputting a new signal. For an optical neural network, the linear collection of signals may be made with optical components (e.g., mirrors, lenses, prisms, diffractive elements, etc.), and the activation function (i.e., the nonlinear response) may be provided by the laser.

Under an injection-locked laser framework, the output of one laser (sometimes referred to as a master laser) is used to control and/or synchronize the emission of another laser (sometimes referred to as a slave laser). Injection-locked operation can involve injecting (at least) a small amount of light from the master laser into the slave laser's cavity. If the frequency of the injected light is sufficiently close to the natural frequency of the slave laser, the slave laser's emission becomes locked to the frequency and phase of the master laser. As a result, the slave laser emits light with the same frequency, phase, and, often, polarization as the master laser, even though the power of the injected light is typically much lower than the power output of the slave laser. Injection locking of lasers can be achieved because the injected light from the master laser modifies the oscillation conditions within the slave laser's cavity. The slave laser's gain medium and cavity are forced to oscillate at the injected frequency, thereby overriding the laser's natural tendency to oscillate at its own independent frequency. This locked state can be maintained over a specific range of frequencies known as the locking range, which can depend on factors such as the power of the injected signal, the detuning between the master and slave frequencies, and the intrinsic properties of the lasers (e.g., linewidths, coupling efficiency, etc.).

Injection-locked lasers have the potential to facilitate numerous advantages and benefits when used as neurons in optical neural networks. For instance, matrices of injection-locked lasers can provide bidirectionality and massive parallelism in the connections between neurons. The neurons, when implemented as injection-locked lasers, can be vastly more connected than conventional hardware acceleration frameworks (e.g., using NPUs, GPUs, ASICS, etc.), which can provide highly accelerated inference times.

Advantageously, because optical signals can be coherent, optical neural networks that utilize injection-locked lasers can encode signals in 1- or 2-dimensional complex numbers, which can increase dimensionality and/or facilitate desired performance with fewer neurons. Further, injection-locked lasers can provide strong nonlinearity (which is desirable for neural networks), where each laser retains the phase of the accumulated input/injected signal while emitting light according to its own pumping rate (i.e., the input phase is retained while the input amplitude is omitted).

Forming matrices of injection-lockable lasers that are usable in optical neural networks is associated with various challenges. In many instances, the lasers should be arranged in layers, with each layer being able to support a sufficiently large number of lasers to function as neurons for neural network tasks. However, conventional solid state lasers (which are typically used for injection-locked functions) include numerous components in addition to the optical cavity and gain medium, including an electrical driver, pump source, cooling system, etc., making it difficult to arrange such lasers in a compact matrix or layer. A typical way to arrange large quantities of lasers in a matrix or layer structure is to use vertical cavity surface emitting lasers (VCSELs) or vertical-external-cavity surface emitting lasers (VECSELs). However, VCSELs and VECSELS are semiconductor-based and are sensitive to power fluctuations, which can cause the laser to oscillate or become chaotic and undermine injection-locking.

At least some disclosed embodiments are directed to laser systems in which laser cavities having a laser gain medium are arranged in a laser cavity matrix. The laser systems also include one or more pump light sources, one or more injection lasers, and one or more light modulators. The light modulator(s) is configured to modulate injection light received from the injection laser(s) to provide input signal light that encodes input data for AI tasks (e.g., training or inference). Each laser cavity includes a laser gain medium and is configured to (i) receive pump light from the pump light source(s) and (ii) receive the input signal light from the light modulator(s). The pump light received by each laser cavity causes stimulated emission within the laser gain medium to generate output laser light. The input signal received by each laser cavity causes injection locking of the output laser light. The output laser light can represent output of a layer of neurons (represented by the matrix/layer of laser cavities), which can be read out as system output and/or can be directed to other laser cavity matrices/layers for forward propagation (e.g., for activation by additional laser matrices/layers acting as additional neuron layers).

In some implementations, the pump light source(s) is implemented as a matrix of semiconductor-based lasers (e.g., VCSELs and/or VECSELs), which, as noted above, can be well-adapted for compact design/arrangements. The laser cavities of the laser cavity matrix form solid state lasers under optical pumping by the pump light source(s), enabling a compact arrangement of lasers that are robust against power fluctuations and therefore well-suited for injection locking (e.g., in contrast with semiconductor lasers). As will be described in more detail hereinbelow, laser cavity matrix can be implemented with additional layers to facilitate temperature management, structural stability, beam shaping, etc.

Having just described some of the various high-level features and benefits associated with the disclosed embodiments, attention will now be directed to the Figures. These Figures illustrate various conceptual representations, architectures, methods, and supporting illustrations related to the disclosed embodiments.

### Laser Matrices for Optical Neural Networks

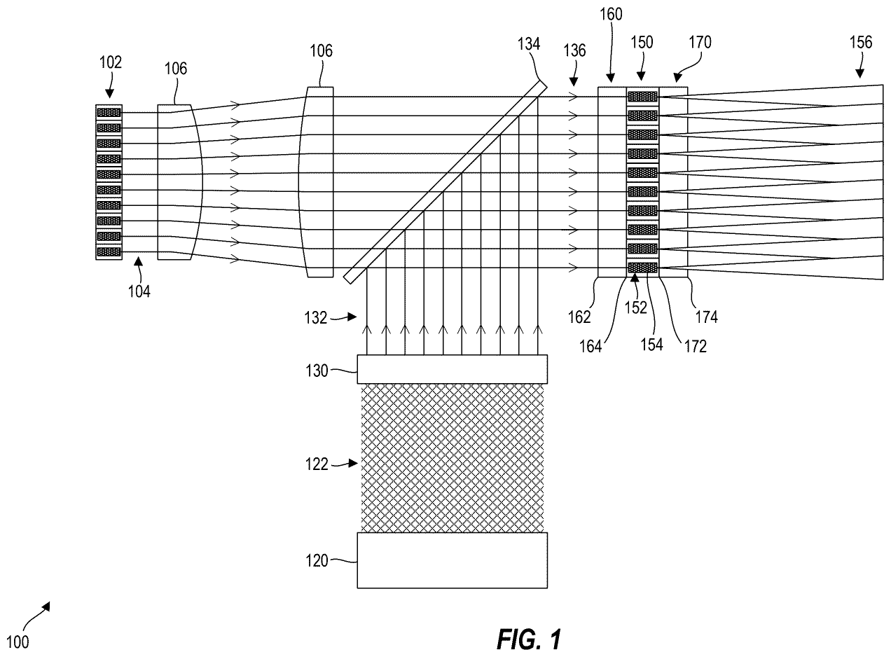

FIG. 1 illustrates a conceptual representation of components of a laser system 100 for optical neural networks. In the example shown in FIG. 1, the laser system 100 includes pump light sources 102, which are configured to generate pump light 104 (represented by an array of lines extending from the pump light sources 102). The pump light sources 102 shown in FIG. 1 includes a matrix of semiconductor-based lasers, such as VCSELs, VECSELs, laser diodes, and/or others. In some implementations, the pump light sources 102 comprise one or more solid state lasers or other types of light sources (e.g., one or more light-emitting diodes (LEDs)).

The laser system 100 shown in FIG. 1 further includes optics 106 adapted to direct the pump light 104 toward a laser cavity matrix 150. The laser cavity matrix 150 includes multiple laser cavities 152 arranged in an array or matrix. Each of the laser cavities 152 includes a laser gain medium 154 (represented in FIG. 1 by the pattern fill within the laser cavities 152) that is configured to receive pump light 104 from the pump light sources 102 (e.g., by receiving one or more of the beams of pump light 104). In the example shown in FIG. 1, the pump light 104 is configured to cause stimulated emission within the laser gain medium 154 of each of the laser cavities 152, causing the laser cavities 152 to generate output laser light 156.

The laser gain medium 154 of each of the laser cavities 152 can take on various forms, such as neodymium (Nd) doped materials, which would emit output laser light 156 at 1064 nm, but other wavelengths are possible (e.g., 1310 nm and/or others). To form the laser gain medium 154 for the laser cavities 152, Nd may be doped into various materials, such as glasses, crystals (e.g., forming Nd: YVO4, Nd: GdVO4, Nd: YAG, and/or others), ceramics, and/or other materials. In some implementations, the laser gain medium 154 comprises ytterbium doped materials (which would emit output laser light 156 within a range of about 1030 nm to about 1050 nm), erbium glass (which would emit output laser light 156 at about 1550 nm), praseodymium doped materials (which would emit output laser light 156 in the visible spectrum), and/or others.

The wavelength of the pump light sources 102 may be selected based on the laser gain medium 154 of the laser cavities 152 and the wavelength of the output laser light 156 generated thereby. In the example shown in FIG. 1, each of the laser cavities 152 of the laser cavity matrix 150 is pumped by pump light 104 from a respective pump light source from the pump light sources 102 (e.g., there is a one-to-one correspondence between the laser cavity matrix 150 and the pump light sources 102). In such cases, the pump light sources 102 may comprise a matrix of individual light sources. Such a configuration may beneficially enable individual modulation of the various light sources forming the pump light sources 102 (e.g., different light sources in the matrix of pump light sources 102 can have different pumping powers or other characteristics).

Although FIG. 1 illustrates an example in which the pump light sources 102 comprise a matrix of lasers, the pump light sources 102 can include a single laser or other light source with one or more optics that modify the output of the single light source to produce a matrix of beams of pump light 104. In one example, a one or more titanium sapphire lasers or high-power semiconductor lasers generate one or more beams, which are divided into multiple additional to provide the pump light 104 for the laser cavity matrix 150. Various optical components may be employed to facilitate division of the beam of the pump light source(s), such as diffraction gratings, microlens arrays, pump masks, and/or others.

The laser system 100 shown in FIG. 1 further includes an injection laser 120 configured to generate injection light 122. The injection light 122 has a wavelength that is longer than the wavelength of the pump light 104. In the example shown in FIG. 1, the laser system 100 further includes a light modulator 130 that receives the injection light 122 from the injection laser 120 and produces input signal light 132. The light modulator 130 modulates the injection light 122 to cause the input signal light 132 to encode input AI model input signals, such as labeled data, unlabeled data, semi-supervised data, synthetic data, augmented data, time-series data, multimodal data, sensor data, streaming data, sparse or incomplete data, and/or other types of data for training or inference purposes.

The light modulator 130 may output the input signal light 132 in the form of an array or matrix of light beams that become directed toward the laser cavities 152 of the laser cavity matrix 150. Although FIG. 1 illustrates an example in which a single injection laser 120 produces injection light 122 that becomes divided into the beams of input signal light 132, other configurations are possible. For example, an array or matrix of injection lasers may be used to produce individual beams that become modulated by the light modulator 130 (any quantity of spatial light modulators may be used). As another example, some embodiments may omit a spatial light modulator, and the input data may instead be encoded directly into the injection light generated by the injection laser(s) via the pumping of the injection laser(s).

In the example shown in FIG. 1, a half-reflecting mirror 134 combines the input signal light 132 from the light modulator 130 with the pump light 104 from the pump light sources 102 to direct combined light 136 toward the laser cavities 152 of the laser cavity matrix 150 (other beam combining optical componentry may be used). Whereas the pump light 104 causes stimulated emission of the laser gain medium 154 within each of the laser cavities 152 to facilitate generation of the output laser light 156 (which can comprise a wavelength that substantially matches the wavelength of the injection light 122 and the input signal light 132), the input signal light 132 causes injection locking of the output laser light 156. The injection locking of the output laser light 156 operates to feed forward the input data (encoded in the input signal light 132) to the laser cavities 152 acting as neurons, enabling the neurons (i.e., the laser cavities 152) to perform nonlinear activation on the received input data and produce an output signal represented in the output laser light 156, which may be fed forward to other components (e.g., readout components such as photodetectors and/or other lasers acting as neurons). For instance, a particular laser cavity from the set of laser cavities 152 can receive light including various components, such as a beam of input signal light 132 output by the light modulator 130 and/or light from other sources (e.g., other laser cavities from the set of laser cavities). The light received by the particular laser cavity can be represented as Z=Σzᵢ, where zᵢ represents the 2-dimensional complex vector indicating electric field amplitudes of the two polarization modes (Jones vector) for light from the light modulator 130 and/or other light sources that is received by the particular laser cavity. The light received by the particular laser cavity can cause injection locking of the particular laser cavity, which can be characterized as weak, strong, or moderate (e.g., exhibiting combined characteristics/components of weak and strong injection locking). Under weak injection locking, the particular laser cavity can output light with an electric field E characterized by:

$$E ( Z ) ∝ \frac{Z}{‖ Z ‖} .$$

Under strong injection locking, the particular laser cavity can output light with an electric field E characterized by:

$$E ( Z ) ∝ Z .$$

This injection-locking of the laser cavities 152 of the laser cavity matrix 150 can thus achieve coupling to the input source(s) (e.g., the injection laser 120 and/or light modulator 130, and/or other light sources) while still preserving the nonlinearity inherent in injection-locked lasers, enabling the laser cavities 152 of the laser cavity matrix 150 to operate as nodes or neurons for an optical neural network to perform machine learning or AI operations.

FIG. 1 illustrates the laser cavity matrix 150 as being abutted by one or more substrates, in particular substrate 160 and substrate 170. The substrates can include various surfaces and can perform various functions, such as improving structural stability, performing heat extraction, controlling beam size or beam divergence, etc. In the example shown in FIG. 1, substrate 160 comprises a heat sink substrate for controlling/managing the temperature of the laser cavity matrix 150, and substrate 170 comprises an output coupling substrate that includes surfaces for controlling beam size and/or beam divergence for the output laser light 156. The surfaces of the laser cavity matrix 150 and/or the substrates 160 and/or 170 can comprise coatings, nanostructures, or other coverings for achieving their various functions, as will be described in more detail below.

The heat sink substrate (e.g., substrate 160) may be transparent or opaque, depending on the geometry used. For a transparent configuration, substrate 160 may be transparent to both the pump light 104 and the input signal light 132. In one example, for a sapphire heat sink with the laser gain medium 154 comprising Nd: YVO4, substrate 160 may be transparent to both the input signal light 132 (e.g., 1064 nm) and the pump light 104 (e.g., 808 nm). For an opaque configuration, substrate 160 can comprise various materials (e.g., metallic materials).

In the example shown in FIG. 1, substrate 160 includes a surface 162 for receiving the combined light 136. In some implementations, surface 162 comprises a thin-film dielectric or other type of coating, which may be highly transmissive for both the wavelength of the input signal light 132 and the wavelength of the pump light 104 (e.g., transmission T≈0.99 and reflection R≈0.01 for both the input signal light 132 wavelength and the pump light 104 wavelength). FIG. 1 furthermore shows substrate 160 as including a surface 164, which is opposite surface 162 and functions as an interface between substrate 160 and the laser cavity matrix 150. In one example, surface 164 comprises a thin-film dielectric or other type of coating that is highly transmissive for the wavelength of the pump light 104 and partially reflective for the wavelength of the input signal light 132 (e.g., pump light 104 transmission Tₚ≈0.99, pump light reflection Rₚ≈0.01, input signal light 132 transmission Tₛ≈0.15, and input signal light 132 reflection Rₛ≈0.85).

In some implementations, substrate 170 operates as a heat sink (e.g., a sapphire heatsink), in addition or as an alternative to substrate 160. Although FIG. 1 provides an example in which the laser cavity matrix 150 is abutted by two substrates 160 and 170, other configurations are possible (e.g., a single substrate abuts the laser cavity matrix 150, or no additional substrate abuts the laser cavity matrix 150).

In the example shown in FIG. 1, substrate 170 includes a surface 174 that can control aspects of the output laser light 156 such as beam divergence. Surface 174 can comprise a thin-film dielectric or other type of coating, which may be highly transmissive for the wavelength of the output laser light 156 (e.g., output laser light 156 transmission Tₛ≈0.99 and output laser light 156 reflection Rₛ≈0.01). In some implementations, surface 174 comprises or abuts a nanostructure or a microlens array or matrix that can control or adjust beam divergence for the output laser light 156.

FIG. 1 also illustrates an example in which substrate 170 includes a surface 172 that is opposite surface 174 and that functions as an interface between substrate 170 and the laser cavity matrix 150. In one example, surface 172 is highly reflective for the pump light 104 and includes partially reflective areas for the wavelength of the input signal light 132 and the output laser light 156 (e.g., pump light 104 transmission Tₚ≈0.01, pump light 104 reflection Rₚ≈0.99, input signal light 132 and output laser light 156 transmission Tₛ≈0.2, and input signal light 132 and output laser light 156 reflection Rₛ≈0.8). In some implementations, surface 172 forms an array or matrix of mirrors (each being aligned with a respective laser cavity 152 of the laser cavity matrix 150), which may be diffractive or curved (e.g., concave) reflective. The mirrors may have dioptric power for laser cavity mode size selection. Surface 172 may be partially reflective for the wavelength of the input signal light 132 and the output laser light 156 at the locations of these mirrors and may have other transmission characteristics in other locations (e.g., highly transmissive for the wavelength of the input signal light 132 and the output laser light 156).

In the example shown in FIG. 1, surfaces 164 and 172 can operate as reflective surfaces or mirrors for the laser cavities 152 of the laser cavity matrix 150, which may comprise curvature (e.g., concavity) or a diffractive pattern to maintain stable reflections for the laser cavities 152. Further, local heat and its gradient with the surrounding material can locally change the index of refraction, therefore keeping the light generated by stimulated emission more confined within the volume of the laser cavities 152.

In an example where the laser gain medium 154 comprise Nd: YVO4, the crystal may be reflective on one side thereof and may comprise nanofabricated cavity mirrors defined on the opposing side thereof. Where concave mirrors are implemented, the diameter of such mirrors may depend on the laser cavity geometry, stability requirements, wavelengths used, and/or desired performance characteristics. For instance, for a wavelength of 1064 nm, the lower end of the mirror diameter may be about 10 μm (large mirrors may be preferred to improve performance and stability, though smaller mirrors may advantageously provide a minimized footprint). In some cases, depending on the mirror diameter and the beam properties and the level of maximum allowed interaction between neighboring lasers, a typical mirror pitch may be within a range of about 30 μm to about 50 μm.

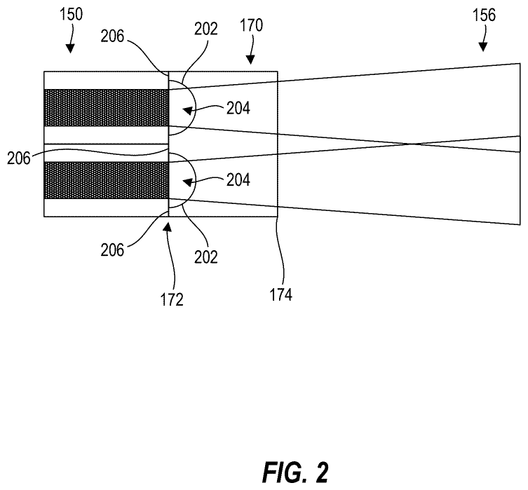

FIG. 2 illustrates a close-up view of components of the laser system 100, including parts of the laser cavity matrix 150 and substrate 170. In the example shown in FIG. 2, coatings or structures may be applied to both the laser cavity matrix 150 and the substrate 170 at the interface between the two. For instance, the laser cavity matrix 150 may be coated (e.g., over the whole surface) between the laser cavity matrix 150 and the substrate 170 that is highly transmissive for the wavelength of the input signal light 132 and the output laser light 156 and that is highly reflective for the wavelength of the pump light 104. Surface 172 of substrate 170 may include portions 202 that define concave recesses 204, which form cavities at the interface between the laser cavity matrix 150 and substrate 170 (the cavities may be filled with any gas or solid). Each portion 202 of surface 172 that defines a concave recess 204 may (e.g., via a coating or nanostructure) have partial reflectivity to the wavelength of the input signal light 132 and the output laser light 156 to contribute to the laser cavity. The portions 206 of surface 172 between the portions 202 that define the concave recesses 204 may be highly transmissive to the wavelength of the input signal light 132 and the output laser light 156. Alternatively, the portions 206 of surface 172 may comprise the same coating or nanostructures as the portions 202 of surface 172 (or a different coating/structure altogether).

Although certain components (e.g., coatings, films, structures) of surfaces 164 and/or 172 are described above as being disposed on the substrates 160 and 170, such components may additionally or alternatively be applied on the laser cavity matrix 150. The laser cavity matrix 150 and substrates 160 and 170 may comprise various optical media thicknesses. In one example, substrates 160 and 170 comprise an optical media thickness within a range of about 2 mm to about 10 mm, and the laser cavity matrix 150 comprises an optical media thickness within a range of about 100 μm to about 2 mm.

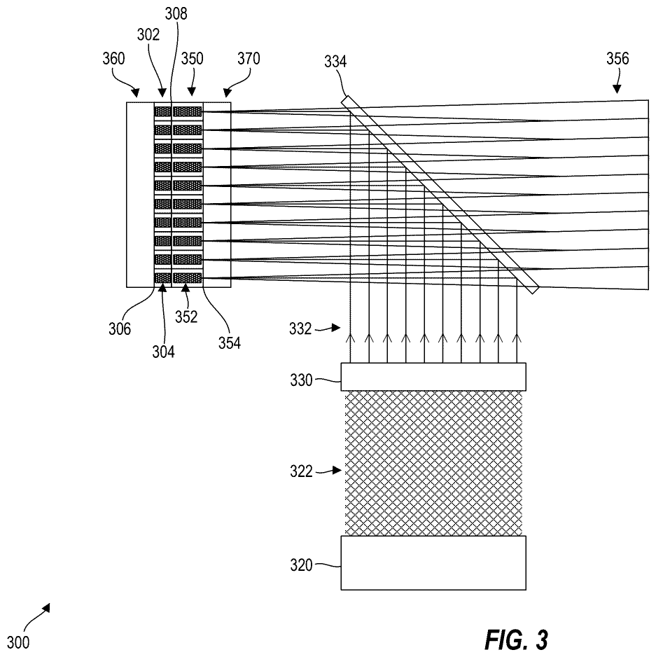

In the example shown in FIG. 1, each of the laser cavities 152 of the laser cavity matrix 150 is arranged to receive the input signal light 132 and the pump light 104 from the same side (e.g., from the side on which substrate 160 abuts the laser cavity matrix 150). Other configurations are possible, as shown in FIG. 3. FIG. 3 illustrates a conceptual representation of components of another laser system 300 for optical neural networks. Similar to the laser system 100, the laser system 300 includes an injection laser 320 configured to generate injection light 322, which is modulated by a light modulator 330 to produce input signal light 332 that encodes input data. The laser system 300 shown in FIG. 3 also includes a laser cavity matrix 350 to which the input signal light 332 is directed (e.g., via a half-reflective mirror 334). The laser cavity matrix 350 receives the input signal light 332 from a first side thereof (e.g., the side on which an optional heat sink substrate 370 abuts the laser cavity matrix 350).

FIG. 3 furthermore illustrates a pump light source 302 implemented as a matrix of pump lasers 304. Each of the pump lasers 304 is aligned with a laser cavity 352 of the laser cavity matrix 350, enabling each of the pump lasers 304 to provide pump light to a respective laser cavity 352. The laser cavity matrix 350 receives the pump light from a second side thereof (e.g., the side on which the pump light source 302 abuts the laser cavity matrix 350, or the side opposite from the side on which the laser cavity matrix 350 receives the input signal light 332).

FIG. 3 illustrates a pump laser cavity for each of the pump lasers 304 (represented in FIG. 3 by the pattern fill within each of the pump lasers 304). In some embodiments, the pump lasers 304 are coupled to the laser cavities 352 of the laser cavity matrix 350 to enable the laser cavities 352 to operate as cavity extensions for the pump lasers 304. For instance, a surface 306 of the pump light source 302 may be highly reflective for the wavelength of the pump light, an interface 308 between the pump light source 302 and the laser cavity matrix 350 may be partially reflective for the wavelength of the pump light, and a surface 354 of the laser cavity matrix 350 may be highly reflective for the wavelength of the pump light, enabling pump light for each pump laser 304 to circulate through a combined cavity formed from cavity of the pump laser 304 and an adjoining laser cavity 352 of the laser cavity matrix 350. Interface 308 between the pump light source 302 and the laser cavity matrix 350 may additionally be highly reflective for the wavelength of the input signal light 332 and the output laser light 356 generated by the laser cavities 352, and surface 354 of the laser cavity matrix 350 may be partially reflective for the wavelength of the input signal light 332 and the output laser light 356. In the example shown in FIG. 3, the laser system 300 includes a heatsink 360 adjacent to the pump light source 302, which may be an opaque heat sink in some implementations.

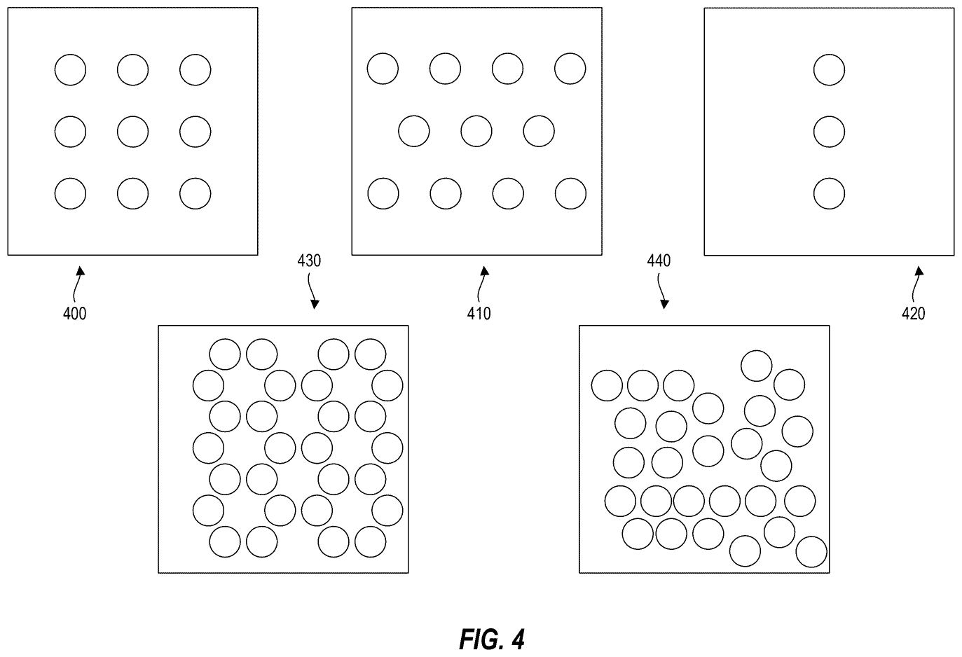

Examples discussed above have referred to matrices or arrays of various components, such as lasers and/or laser cavities. One will appreciate, in view of the present disclosure, that a matrix or array of components does not refer to any particular lattice or pattern of components, and that any arrangement of components on a common plane can comprise a “matrix” or “array” as described herein. For example, FIG. 4 illustrates a facing view of example matrix configurations for laser cavities, pump lasers, or other components of a laser system as described herein. Matrix 400 comprises a rectangular lattice, matrix 410 comprises a triangular lattice, matrix 420 comprises a column or row arrangement, matrix 430 comprises a honeycomb lattice, and matrix 440 comprises an irregular lattice, illustrating that a matrix or array as described herein can have any suitable pattern configuration.

### Example Embodiments

Embodiments disclosed herein can include those in the following numbered clauses:

Clause 1. A laser system, comprising: one or more pump light sources configured to generate pump light, the pump light comprising a first wavelength; one or more injection lasers configured to generate injection light, the injection light comprising a second wavelength that is longer than the first wavelength; one or more light modulators configured to selectively modulate the injection light received from the one or more injection lasers to produce input signal light; and a laser cavity matrix comprising a plurality of laser cavities, wherein each laser cavity of the plurality of laser cavities comprises a laser gain medium and is configured to (i) receive pump light from the one or more pump light sources to cause stimulated emission within the laser gain medium to generate an output laser light and (ii) receive input signal light from the one or more light modulators to cause injection locking of the output laser light.

Clause 2. The laser system of clause 1, wherein the one or more pump light sources comprise a matrix of vertical-cavity surface-emitting lasers (VCSELs), a matrix of vertical-external-cavity surface emitting lasers (VECSELs), or a matrix of laser diodes.

Clause 3. The laser system of clause 1, wherein the one or more light modulators are configured to selectively modulate the injection light received from the one or more injection lasers such that the input signal light encodes one or more artificial intelligence model input signals.

Clause 4. The laser system of clause 1, wherein each laser cavity of the plurality of laser cavities is configured to receive the pump light and the input signal light from a same side of the laser cavity matrix.

Clause 5. The laser system of clause 1, wherein each laser cavity of the plurality of laser cavities is configured to receive the pump light from a first side of the laser cavity matrix and receive the input signal light from a second side of the laser cavity matrix.

Clause 6. The laser system of clause 5, wherein the one or more pump light sources are coupled with the laser cavity matrix such that laser cavities of the plurality of laser cavities of the laser cavity matrix operate as pump laser cavity extensions for the one or more pump light sources.

Clause 7. The laser system of clause 1, wherein a wavelength of the output laser light substantially matches the second wavelength.

Clause 8. The laser system of clause 1, further comprising one or more substrates abutting the laser cavity matrix.

Clause 9. The laser system of clause 8, wherein the one or more substrates comprise an output coupling substrate comprising one or more surfaces adapted for controlling beam size or beam divergence for the output laser light.

Clause 10. The laser system of clause 9, wherein the one or more surfaces comprise one or more coatings or one or more nanostructures.

Clause 11. The laser system of clause 9, wherein the output coupling substrate defines a plurality of concave recesses such that the laser cavity matrix and the output coupling substrate define a plurality of cavities at an interface between the output coupling substrate and the laser cavity matrix.

Clause 12. A laser system, comprising: one or more pump light sources configured to generate pump light, the pump light comprising a first wavelength; one or more injection lasers configured to generate injection light, the injection light comprising a second wavelength that is longer than the first wavelength; one or more light modulators configured to selectively modulate the injection light received from the one or more injection lasers to produce input signal light; and a laser cavity matrix comprising a plurality of laser cavities, wherein each laser cavity of the plurality of laser cavities comprises a laser gain medium and is configured to (i) receive pump light from the one or more pump light sources to cause stimulated emission within the laser gain medium to generate an output laser light and (ii) receive input signal light from the one or more light modulators to cause injection locking of the output laser light, wherein each laser cavity of the plurality of laser cavities is configured to receive the pump light and the input signal light from a same side of the laser cavity matrix.

Clause 13. The laser system of clause 12, wherein the one or more pump light sources comprise a matrix of vertical-cavity surface-emitting lasers (VCSELs), a matrix of vertical-external-cavity surface emitting lasers (VECSELs), or a matrix of laser diodes.

Clause 14. The laser system of clause 12, wherein the one or more light modulators are configured to selectively modulate the injection light received from the one or more injection lasers such that the input signal light encodes one or more artificial intelligence model input signals.

Clause 15. The laser system of clause 12, further comprising one or more substrates abutting the laser cavity matrix.

Clause 16. The laser system of clause 15, wherein the one or more substrates comprise an output coupling substrate comprising one or more surfaces adapted for controlling beam size or beam divergence for the output laser light.

Clause 17. The laser system of clause 16, wherein the one or more surfaces comprise one or more coatings or one or more nanostructures.

Clause 18. The laser system of clause 16, wherein the output coupling substrate defines a plurality of concave recesses such that the laser cavity matrix and the output coupling substrate define a plurality of cavities at an interface between the output coupling substrate and the laser cavity matrix.

Clause 19. A laser system, comprising: one or more pump light sources configured to generate pump light, the pump light comprising a first wavelength; one or more injection lasers configured to generate injection light, the injection light comprising a second wavelength that is longer than the first wavelength; one or more light modulators configured to selectively modulate the injection light received from the one or more injection lasers to produce input signal light; and a laser cavity matrix comprising a plurality of laser cavities, wherein each laser cavity of the plurality of laser cavities comprises a laser gain medium and is configured to (i) receive pump light from the one or more pump light sources to cause stimulated emission within the laser gain medium to generate an output laser light and (ii) receive input signal light from the one or more light modulators to cause injection locking of the output laser light, wherein each laser cavity of the plurality of laser cavities is configured to receive the pump light from a first side of the laser cavity matrix and receive the input signal light from a second side of the laser cavity matrix.

Clause 20. The laser system of clause 19, wherein the one or more pump light sources are coupled with the laser cavity matrix such that laser cavities of the plurality of laser cavities of the laser cavity matrix operate as pump laser cavity extensions for the one or more pump light sources.

### ADDITIONAL DETAILS RELATED TO THE DISCLOSED EMBODIMENTS

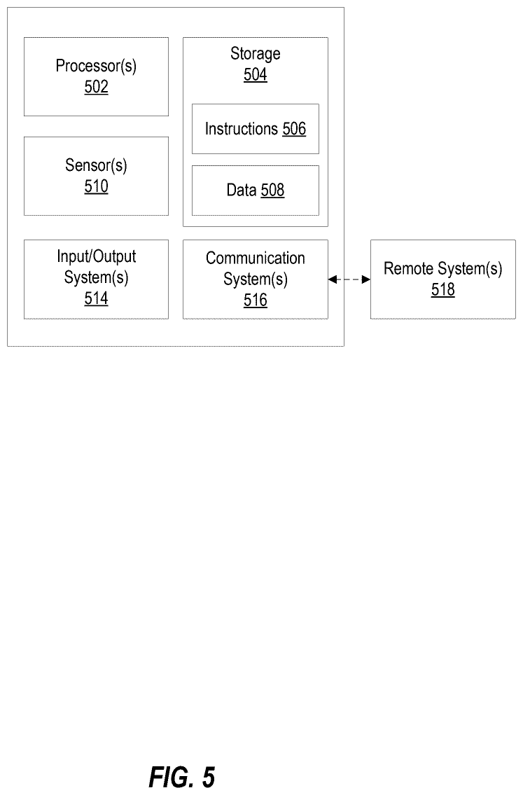

FIG. 5 illustrates various example components of a system 500 that may be used when implementing one or more disclosed embodiments (e.g., control/pump the lasers, to control the light modulator(s), to control the optical cross-connects, to control the photodetector(s), etc.). For example, FIG. 5 illustrates that a system 500 may include processor(s) 502, storage 504, sensor(s) 510, input/output system(s) 514 (I/O system(s) 514), and communication system(s) 516. Although FIG. 5 illustrates a system 500 as including particular components, one will appreciate, in view of the present disclosure, that a system 500 may comprise any number of additional or alternative components.

The processor(s) 502 may comprise one or more sets of electronic circuitries that include any number of logic units, registers, and/or control units to facilitate the execution of computer-readable instructions (e.g., instructions that form a computer program). Processor(s) 502 may take on various forms, such as, by way of non-limiting example, Field-programmable Gate Arrays (FPGAs), application-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

Computer-readable instructions may be stored within storage 504. The storage 504 may comprise physical system memory and may be volatile, non-volatile, or some combination thereof. Furthermore, storage 504 may comprise local storage, remote storage (e.g., accessible via communication system(s) 516 or otherwise), or some combination thereof. Additional details related to processors (e.g., processor(s) 502) and computer storage media (e.g., storage 504) will be provided hereinafter.

In some implementations, the processor(s) 502 may comprise or be configurable to execute any combination of software and/or hardware components that are operable to facilitate processing using machine learning models or other artificial intelligence-based structures/architectures. For example, processor(s) 502 may comprise and/or utilize hardware components or computer-executable instructions operable to carry out function blocks and/or processing layers configured in the form of, by way of non-limiting example, fully connected layers, convolutional layers, pooling layers, recurrent layers, embedding layers, dropout layers, normalization layers, attention layers, transformer layers, flatten layers, and/or others without limitation.

As will be described in more detail, the processor(s) 502 may be configured to execute instructions 506 stored within storage 504 to perform certain actions. The actions may rely at least in part on data 508 stored on storage 504 in a volatile or non-volatile manner.

In some instances, the actions may rely at least in part on communication system(s) 516 for receiving data from remote system(s) 518, which may include, for example, separate systems or computing devices, sensors, and/or others. The communications system(s) 516 may comprise any combination of software or hardware components that are operable to facilitate communication between on-system components/devices and/or with off-system components/devices. For example, the communications system(s) 516 may comprise ports, buses, or other physical connection apparatuses for communicating with other devices/components. Additionally, or alternatively, the communications system(s) 516 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 5 illustrates that a system 500 may comprise or be in communication with sensor(s) 510. Sensor(s) 510 may comprise any device for capturing or measuring data representative of perceivable or detectable phenomena. By way of non-limiting example, the sensor(s) 510 may comprise one or more radar sensors, image sensors, microphones, thermometers, barometers, magnetometers, accelerometers, gyroscopes, and/or others.

Furthermore, FIG. 5 illustrates that a system 500 may comprise or be in communication with I/O system(s) 514. I/O system(s) 514 may include any type of input or output device such as, by way of non-limiting example, a touch screen, a mouse, a keyboard, a controller, and/or others, without limitation. For example, the I/O system(s) 514 may include a display system that may comprise any number of display panels, optics, laser scanning display assemblies, and/or other components.

At least some components of the system 500 may comprise or utilize various types of devices, such as servers, workstations, clusters, pods, edge devices, mobile electronic devices (e.g., smartphones), personal computing devices (e.g., a laptops), wearable devices (e.g., smartwatches, HMDs, etc.), vehicles (e.g., aerial vehicles, autonomous vehicles, etc.), and/or other devices. A system 500 may take on other forms in accordance with the present disclosure.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“laaS”), and deployment models (e.g., private cloud, community cloud, public cloud, hybrid cloud, etc.).

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

As used herein, the term “about”, when used to modify a numerical value or range, refers to any value within 5%, 10%, 15%, 20%, or 25% of the numerical value modified by the term “about”.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We currently claim:

1. A laser system, comprising:
one or more pump light sources configured to generate pump light, the pump light comprising a first wavelength;
one or more injection lasers configured to generate injection light, the injection light comprising a second wavelength that is longer than the first wavelength;
one or more light modulators configured to selectively modulate the injection light received from the one or more injection lasers to produce input signal light; and
a laser cavity matrix comprising a plurality of laser cavities, wherein each laser cavity of the plurality of laser cavities comprises a laser gain medium and is configured to (i) receive pump light from the one or more pump light sources to cause stimulated emission within the laser gain medium to generate an output laser light and (ii) receive input signal light from the one or more light modulators to cause injection locking of the output laser light.

2. The laser system of claim 1, wherein the one or more pump light sources comprise a matrix of vertical-cavity surface-emitting lasers (VCSELs), a matrix of vertical-external-cavity surface emitting lasers (VECSELs), or a matrix of laser diodes.

3. The laser system of claim 1, wherein the one or more light modulators are configured to selectively modulate the injection light received from the one or more injection lasers such that the input signal light encodes one or more artificial intelligence model input signals.

4. The laser system of claim 1, wherein each laser cavity of the plurality of laser cavities is configured to receive the pump light and the input signal light from a same side of the laser cavity matrix.

5. The laser system of claim 1, wherein each laser cavity of the plurality of laser cavities is configured to receive the pump light from a first side of the laser cavity matrix and receive the input signal light from a second side of the laser cavity matrix.

6. The laser system of claim 5, wherein the one or more pump light sources are coupled with the laser cavity matrix such that laser cavities of the plurality of laser cavities of the laser cavity matrix operate as pump laser cavity extensions for the one or more pump light sources.

7. The laser system of claim 1, wherein a wavelength of the output laser light substantially matches the second wavelength.

8. The laser system of claim 1, further comprising one or more substrates abutting the laser cavity matrix.

9. The laser system of claim 8, wherein the one or more substrates comprise an output coupling substrate comprising one or more surfaces adapted for controlling beam size or beam divergence for the output laser light.

10. The laser system of claim 9, wherein the one or more surfaces comprise one or more coatings or one or more nanostructures.

11. The laser system of claim 9, wherein the output coupling substrate defines a plurality of concave recesses such that the laser cavity matrix and the output coupling substrate define a plurality of cavities at an interface between the output coupling substrate and the laser cavity matrix.

12. A laser system, comprising:
one or more pump light sources configured to generate pump light, the pump light comprising a first wavelength;
one or more injection lasers configured to generate injection light, the injection light comprising a second wavelength that is longer than the first wavelength;
one or more light modulators configured to selectively modulate the injection light received from the one or more injection lasers to produce input signal light; and
a laser cavity matrix comprising a plurality of laser cavities, wherein each laser cavity of the plurality of laser cavities comprises a laser gain medium and is configured to (i) receive pump light from the one or more pump light sources to cause stimulated emission within the laser gain medium to generate an output laser light and (ii) receive input signal light from the one or more light modulators to cause injection locking of the output laser light, wherein each laser cavity of the plurality of laser cavities is configured to receive the pump light and the input signal light from a same side of the laser cavity matrix.

13. The laser system of claim 12, wherein the one or more pump light sources comprise a matrix of vertical-cavity surface-emitting lasers (VCSELs), a matrix of vertical-external-cavity surface emitting lasers (VECSELs), or a matrix of laser diodes.

14. The laser system of claim 12, wherein the one or more light modulators are configured to selectively modulate the injection light received from the one or more injection lasers such that the input signal light encodes one or more artificial intelligence model input signals.

15. The laser system of claim 12, further comprising one or more substrates abutting the laser cavity matrix.

16. The laser system of claim 15, wherein the one or more substrates comprise an output coupling substrate comprising one or more surfaces adapted for controlling beam size or beam divergence for the output laser light.

17. The laser system of claim 16, wherein the one or more surfaces comprise one or more coatings or one or more nanostructures.

18. The laser system of claim 16, wherein the output coupling substrate defines a plurality of concave recesses such that the laser cavity matrix and the output coupling substrate define a plurality of cavities at an interface between the output coupling substrate and the laser cavity matrix.

19. A laser system, comprising:
one or more pump light sources configured to generate pump light, the pump light comprising a first wavelength;
one or more injection lasers configured to generate injection light, the injection light comprising a second wavelength that is longer than the first wavelength;
one or more light modulators configured to selectively modulate the injection light received from the one or more injection lasers to produce input signal light; and
a laser cavity matrix comprising a plurality of laser cavities, wherein each laser cavity of the plurality of laser cavities comprises a laser gain medium and is configured to (i) receive pump light from the one or more pump light sources to cause stimulated emission within the laser gain medium to generate an output laser light and (ii) receive input signal light from the one or more light modulators to cause injection locking of the output laser light, wherein each laser cavity of the plurality of laser cavities is configured to receive the pump light from a first side of the laser cavity matrix and receive the input signal light from a second side of the laser cavity matrix.

20. The laser system of claim 19, wherein the one or more pump light sources are coupled with the laser cavity matrix such that laser cavities of the plurality of laser cavities of the laser cavity matrix operate as pump laser cavity extensions for the one or more pump light sources.
